(19) United States
(12) Patent Application Publication
(10) Pub. No.: US 2026/0166827 A1
(43) Pub. Date: Jun. 18, 2026

(54) PNEUMATIC VEHICLE TYRE AND VULCANISING MOULD

(71) Applicant: Continental Reifen Deutschland GmbH, Hannover (DE)

(72) Inventors: Florian Kristen, Burgwedel (DE); André Lutz, Hannover (DE); Ute Volkmann, Garbsen (DE)

(73) Assignee: Continental Reifen Deutschland GmbH, Hannover (DE)

(21) Appl. No.: 18/716,411

(22) PCT Filed: Dec. 16, 2021
(86) PCT No.: PCT/DE2021/200264

§ 371 Date: Jun. 4, 2024

(51) Int. Cl. B29D 30/06; B60C 11/03; B60C 13/00

(52) U.S. Cl. CPC B29D 30/0606; B29D 30/0629; B60C 11/032; B60C 13/001; B29D 2030/0612

(57) ABSTRACT

A pneumatic vehicle tire comprises a tread with shoulder flanks, sidewalls and bead regions. The tire is vulcanized in a vulcanizing mold with a plurality of segments of a segment ring that are arranged movably in the radial direction for forming the tread and the shoulder flanks, with sidewall shells for forming the outer sides of the sidewalls and with mold partitions between the segments and the sidewall shells, wherein the shoulder flanks together with those regions that correspond to the positions of the mold partitions continuously adjoin the outer sides of the sidewalls such that the shoulder flanks are in line with the outer sides of the sidewalls. Radially within the regions that correspond to the positions of the mold partitions, in each case there directly adjoins a portion of the sidewall which, when the tire is viewed from the side, forms a circumferential flat surface running around in the form of a circular ring, with a radial extent of 10.00 mm to 25.00 mm, and which merges tangentially into the outer side of a further portion of the sidewall which has a thin amount of extra material of 0.50 mm to 1.50 mm and in radial section is curved outward in the form of a circular arc.

The present application is a National Stage Application under 35 U.S.C. §371 of International Patent Application No. PCT/DE2021/200264 filed on Dec. 16, 2021, the disclosures of which are herein incorporated by reference in their entireties.

### BRIEF SUMMARY

The invention relates to a pneumatic vehicle tire with a tread with shoulder flanks, sidewalls and bead regions, which tire is vulcanized in a vulcanizing mold with a plurality of segments of a segment ring that are arranged movably in the radial direction for forming the tread and the shoulder flanks, with sidewall shells for forming the outer sides of the sidewalls and with mold partitions between the segments and the sidewall shells, wherein the shoulder flanks together with those regions that correspond to the positions of the mold partitions continuously adjoin the outer sides of the sidewalls such that the shoulder flanks are in line with the outer sides of the sidewalls.

The invention also relates to a pneumatic vehicle tire, as formed immediately after vulcanization in a vulcanizing mold, which vulcanizing mold is provided with a plurality of segments of a segment ring that are arranged movably in the radial direction for forming the tread with shoulder flanks, with sidewall shells for forming the sidewalls and with mold partitions between the segments and the sidewall shells, wherein, formed on the outer side of the tire, along those regions that correspond to the positions of the mold partitions, are ribs, which run around in the circumferential direction and are delimited by a radially inner and a radially outer rib flank, and wherein the shoulder flanks are in line with the outer sides that are located radially within the ribs and are interrupted by the ribs.

The invention also relates to a vulcanizing mold for vulcanizing a pneumatic vehicle tire, with a number of segments of a segment ring that are arranged movably in the radial direction for forming a tread with shoulder flanks, also with sidewall shells for forming sidewalls and with mold partitions between the segments and the sidewall shells, wherein, with the mold closed, the sidewall shells are in contact with the segments of the segment ring at the mold partitions, wherein respectively formed at the end on the inner side of the mold, along the mold partition, is a circumferential depression, which is delimited by two depression flanks, one of which is formed on the segments and the other of which is formed on the sidewall shell, and wherein, around the region of the mold partitions, the mold inner sides are in line with one another, interrupted by the depressions.

Such pneumatic vehicle tires and such a vulcanizing mold are known, for example, from DE 10 2014 212 346 A1. The pneumatic vehicle tire is vulcanized in a vulcanizing mold which forms ribs running along the mold partitions and having a V-shaped or a dome-shaped cross section with sharp corners at the shoulder flanks and the sidewalls. When closing the vulcanizing mold and vulcanizing the green tire, rubber material penetrates into the area of the mold partition between the segments adjacent to the sidewall shells in the closed state of the vulcanizing mold and forms flash on the tips of the ribs as short thin films of rubber. The circumferential ribs, together with the flash, are completely cut off on the finished vulcanized tire before it is delivered. Cutting off the ribs leaves on the sides of the tire scarcely visible narrow circumferential stripes with an outer surface that is smoother than that of the adjoining shoulder flanks and that of the adjoining sidewalls.

The vulcanizing mold forming the tire according to DE 10 2014 212 346 A1 has depressions with depression flanks on the inner side of the mold, along the mold partition, one of which is provided on the profile ring segments and the other of which is provided on the respective sidewall shell. The mold partition therefore begins at the bottom of these depressions. The ribs formed in this way on the pneumatic vehicle tire, which are also referred to as trimming ribs, contain a certain volume of rubber and by their corners repeatedly cause cracks in the rubber material on the outer side of the tire when they are separated from the rubber material of the sidewalls and the shoulder flanks.

Sidewall inscriptions and sidewall designs are transferred to the sidewalls via the sidewall shells during the vulcanization of the tire. Recently, sidewall inscriptions and sidewall designs have preferably been imprinted into the rubber material of the sidewalls as shallow depressions. A visually uniform and flawless design of the lateral outer sides of the tires, without projections and steps, is desired, while ensuring the possibility that sidewall inscriptions and sidewall designs can be imprinted into the rubber material as depressions with minimal expenditure of material.

The invention is therefore based on the object of providing tires with a visually uniform design of the sides of the tire, especially taking into account low expenditure of material and at the same time the possibility of producing the tire with recessed sidewall inscriptions and/or sidewall designs.

The stated object is achieved by a pneumatic vehicle tire in which, radially within the regions that correspond to the positions of the mold partitions, in each case there directly adjoins a portion of the sidewall which, when the tire is viewed from the side, forms a circumferential flat surface running around in the form of a circular ring, with a radial extent of 10.00 mm to 25.00 mm, and which merges tangentially into the outer side of a further portion of the sidewall which has a thin amount of extra material of 0.50 mm to 1.50 mm and in radial section is curved outward in the form of a circular arc.

This design avoids the formation of steps at the transition to the extra material, which allows the imprinting of recessed sidewall inscriptions and/or sidewall designs, and at the same time the expenditure of material for the extra material can be limited to just the amount required. Overall, this reduces the rolling resistance and the air resistance of the tire.

With regard to the pneumatic vehicle tire as it is formed immediately after vulcanization in a vulcanizing mold, the stated object is achieved by the fact that the rib flanks of the ribs are curved inward in radial section.

The trimming ribs can therefore be formed with lower expenditure of material than in the prior art according to DE 10 2014 212 346 A1, wherein the inward curvature of the rib flanks allows a gently rounded transition of the rib flanks into the shoulder flanks and the sidewalls and ensures during the subsequent separation of the ribs that cracks no longer occur on the rubber material of the sidewall or the shoulder flank of the tire.

The vulcanizing mold according to the invention is characterized in that the depression flanks of the depressions are curved outward in radial section.

The ribs formed in this way during vulcanization have an optimally reduced volume of rubber and, after separation, ensure a visually uniform appearance of the sides of the tire without kinks and cracks.

In a preferred embodiment, the pneumatic vehicle tire according to the invention is a commercial vehicle tire in which the further portion of the sidewall curved in the form of a circular arc is based on a circular arc with a radius of 150.00 mm to 200.00 mm. In the case of commercial vehicle tires, the lower air resistance of the tires that can be achieved by using less material and the special design has a particularly advantageous effect.

In a preferred embodiment, the further portion of the sidewall curved in the form of a circular arc extends up to or almost up to the bead region. Without affecting a uniform design of the sidewalls, a relatively large area of the sidewalls can thus be provided with sidewall inscriptions or sidewall designs in the form of depressions.

In the case of a pneumatic vehicle tire as it is formed immediately after vulcanization in a vulcanizing mold, it is of particular advantage if the rib flanks of the ribs merge tangentially both into the shoulder flanks and into the outer sides of the sidewalls. This makes it possible to separate the ribs particularly cleanly and largely without any residue before the tires are delivered.

In this connection it is advantageous if the curvature of the radially outer rib flank in the form of a circular arc is based on a circular arc with a radius which is in particular at least 0.20 mm greater than the radius of that circular arc which forms the basis for the curvature of the radially inner rib flank in the form of a circular arc, wherein the curvature of the radially outer rib flank in the form of a circular arc is based on a circular arc with a radius which is 1.30 mm to 2.50 mm, and wherein the curvature of the radially inner rib flank in the form of a circular arc is based on a circular arc with a radius which is 1.10 mm to 1.50 mm.

A clean and flawless separation of the ribs is further assisted in particular by the ribs having a height of 1.00 mm to 2.50 mm, in particular of 1.30 mm to 1.70 mm.

The pneumatic vehicle tire obtained immediately after vulcanization, as well as the pneumatic vehicle tire ready for delivery, has a sidewall with a portion which, when the tire is viewed from the side, forms a circumferential flat surface running around in the form of a circular ring, with a radial extent of 10.00 mm to 25.00 mm, and which merges tangentially into the outer side of a further portion of the sidewall that is formed by a thin amount of extra material of 0.50 mm to 1.50 mm and in radial section is curved outward in the form of a circular arc. In this further portion of the sidewall curved outward in the form of a circular arc, sidewall inscriptions, sidewall designs and the like have been imprinted as depressions during the vulcanization of the tire. If the tire is a commercial vehicle tire and as already mentioned, this further portion of the sidewall curved in the form of a circular arc is based on a circular arc with a radius of 150.00 mm to 200.00 mm.

The vulcanizing mold ensures by means of depressions that the ribs mentioned are formed on the lateral outer sides of the tire, wherein the depression flanks are designed in a way corresponding to the preferred design of the ribs to be formed. The special designs of the depressions in this respect include, for example, that the depression flanks of the depressions merge tangentially into the inner side of the segments and the sidewall shells, wherein a curvature of the radially outer depression flank in the form of a circular arc is based on a circular arc with a radius which is 1.30 mm to 2.00 mm and wherein a curvature of the radially inner depression flank in the form of a circular arc is based on a circular arc with a radius which is 1.10 mm to 1.50 mm.

For the formation of ribs that can be separated cleanly and largely without any residue, it is advantageous if the depressions have a depth of 1.00 mm to 2.50 mm, in particular of 1.30 mm to 1.70 mm.

### BRIEF DESCRIPTION OF DRAWINGS

Further features, advantages and details of the invention will now be described in more detail on the basis of the schematic drawing, which illustrates an exemplary embodiment. In the drawing:
FIG. 1 shows a detail of a radial cross section of a pneumatic vehicle tire immediately after vulcanization in a vulcanizing mold,

FIG. 2 shows the detail D from FIG. 1 in an enlarged representation and

FIG. 3 shows a detail of a radial cross section of a segment of a profile ring and adjoining it a sidewall shell of a vulcanizing mold of a pneumatic vehicle tire.

### DETAILED DESCRIPTION

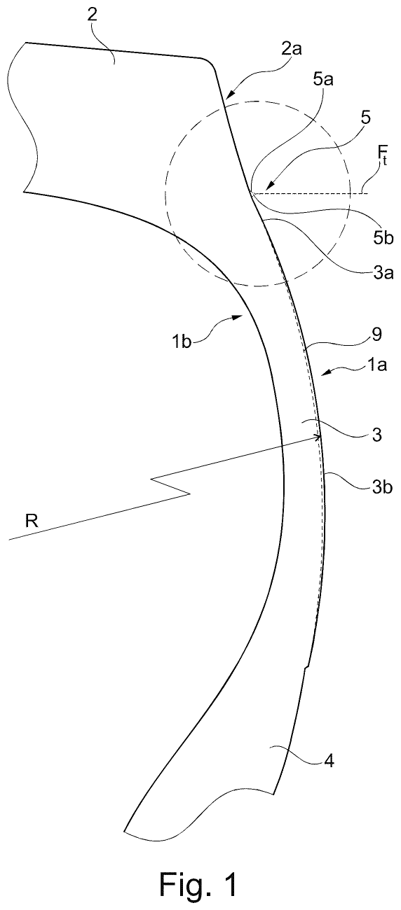

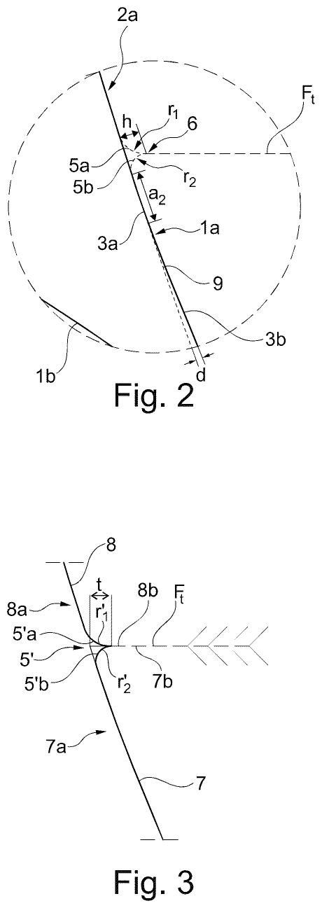

The sectional view in FIG. 1 and the detail D according to FIG. 2 schematically show the contour of the outer side 1a and the contour of the inner side 1b of a portion of a pneumatic vehicle tire, which by way of example is a commercial vehicle tire. However, the invention is equally applicable to tires of other types, for example tires for passenger cars, vans, light trucks or industrial tires. Shown are a part of a tread 2 with a shoulder flank 2a, also a sidewall 3 and a bead region 4. The other tire components that are usually provided are not shown and may be designed in a known manner.

Immediately after the vulcanization of the tire in a vulcanizing mold, at the radially inner end of the shoulder flank 2a on the outer side 1a of the pneumatic vehicle tire there is a rib 5, which is indicated by dashed lines in FIG. 1 and FIG. 2 and has two tapered rib flanks 5a, 5b and which has been formed in the vulcanizing mold in the region of the mold partition between a sidewall shell and segments of a profile ring, as will be described on the basis of FIG. 3. The position of the mold partition is indicated in FIG. 1 and FIG. 2 by a line Fₜ. The rib 5 runs circumferentially around the sidewall 3; at its tip there is flash formed as a thin film of rubber 6 during the vulcanization of the tire. The outer side 1a of the tire is designed in the region around the rib 5 such that the shoulder flank 2a is in line with a portion 3a of the outer side 1a directly adjoining radially within the rib 5 in the region of the sidewall 3. The portion 3a of the sidewall 3 directly adjoining radially within the rib 5 is, when the tire is viewed from the side, formed as a circumferential flat surface running around in the form of a circular ring, with a radial extent a₁ of in each case 10.00 mm to 25.00 mm, depending on the tire dimension and tire type. The portion 3a merges over a tangential transition into a further portion 3b of the sidewall 3 which is formed by a thin amount of extra material 9 of 0.50 mm to 1.50 mm (thickness d in FIG. 2)—with respect to the dashed line in FIG. 2—and curved outward in the form of a circular arc with a radius R and on which a recessed, therefore imprinted, sidewall inscription and/or a recessed sidewall design may be formed in a known way. In the case of a commercial vehicle tire, the radius R is in the range of 150.00 mm to 200.00 mm. The extra material 9 is outside the tangential transition and, with respect to the portion 3a, is a thickening of the rubber material in portion 3a, in particular having a constant thickness d.

The rib flanks 5a, 5b are curved inward in radial section, and therefore concavely, in particular as circular arcs extending from the tip of the rib 5 to the level of the shoulder flank 2a and of the portion 3a respectively, and merging into these portions without kinks, in particular tangentially. The curvature of the radially outer rib flank 5a in the form of a circular arc is based on a circular arc with a radius r₁ of 1.30 mm to 2.50 mm; the curvature of the radially inner rib flank 5b in the form of a circular arc is based on a circular arc with a radius r₂ of 1.10 mm to 1.50 mm, where r₂ is at least 0.20 mm smaller than r₁. The rib 5 has a height h, which is determined at right angles to a straight line connecting the shoulder flank 2a to the portion 3a and is 1.00 mm to 2.50 mm, in particular 1.30 mm to 1.70 mm. After vulcanization of the tire and before its delivery, the ribs 5 together with the film of rubber 6 are manually or automatically separated or cut off with a trimming knife.

The pneumatic vehicle tire is vulcanized in a vulcanizing mold which has a profile ring forming the tread and comprising a number of segments that are movable in the radial direction and sidewall shells that are movable in the axial direction. FIG. 3 schematically shows the course of the inner side 7a of a sidewall shell 7 and the inner side 8a of the adjoining segment 8 of the profile ring. In the closed state of the vulcanizing mold, a delimiting surface 8b of the segments 8 lies closely against a delimiting surface 7b of the sidewall shell 7 and thereby forms the mold partition Fₜ. In the detail shown, the segment 8 forms the shoulder flank 2a of the pneumatic vehicle tire, the sidewall shell 7 forms the portions 3a and 3b on the sidewall 3. Formed at the end on the inner side of the mold and along the mold partition Ft is a depression 5′, which is delimited by two depression flanks 5′a and 5′b, one of which is formed on the segments 8 and the other of which is formed on the sidewall shell 7. After the depression 5′ forms the rib 5 on the tire, the depression flanks 5′a and 5′b are curved convexly, i.e. outward, in particular in the form of a circular arc with radii r₁′ and r₂′ analogous to the radii r₁ and r₂, and in particular thereby form tangential transitions to the inner sides of the segments 8 and the sidewall shell 7. The depressions 5′ have a depth t of 1.00 mm to 2.50 mm, in particular of 1.30 mm to 1.70 mm.

As a result of this design of the vulcanizing mold, immediately after vulcanization and removal from the mold, a pneumatic vehicle tire vulcanized in it has on each of its sides a circumferential rib 5 with flash protruding at its tip in a film-like manner.

### LIST OF REFERENCE SIGNS

1a . . . Outer side
1b . . . Inner side
2 . . . Tread
2a . . . Shoulder flank
3 . . . Sidewall
4 . . . Bead region
5 . . . Rib
5′ . . . Depression
5a, 5b . . . Rib flank
5′a, 5′b . . . Depression flank
6 . . . Film of rubber
7 . . . Sidewall shell
7a . . . Inner side
7b . . . Delimiting surface
8 . . . Segment
8a . . . Inner side
8b . . . Delimiting surface
9 . . . Extra material
r₁, r₂ . . . Radius
r₁′, r₂′ . . . Radius
R . . . Radius
Fₜ . . . Mold partition
t . . . Depth
h . . . Height

1. A pneumatic vehicle tire comprising:
a tread with shoulder flanks;
sidewalls; and
bead regions;
wherein the tire is vulcanized in a vulcanizing mold with a plurality of segments of a segment ring that are arranged movably in the radial direction for forming the tread and the shoulder flanks with sidewall shells for forming the outer sides of the sidewalls and with mold partitions between the segments and the sidewall shells, wherein the shoulder flanks together with those regions that correspond to the positions of the mold partitions continuously adjoin the outer sides of the sidewalls such that the shoulder flanks are in line with the outer sides of the sidewalls;
wherein, radially within the regions that correspond to the positions of the mold partitions in each case there directly adjoins a portion of the sidewall which, when the tire is viewed from the side, forms a circumferential flat surface running around in the form of a circular ring, with a radial extent of 10.00 mm to 25.00 mm, and which merges tangentially into the outer side of a further portion of the sidewall which has a thin amount of extra material of 0.50 mm to 1.50 mm and in radial section is curved outward in the form of a circular arc.

2. The pneumatic vehicle tire as claimed in claim 1, wherein the further portion of the sidewall is curved in the form of a circular arc is based on a circular arc with a radius of 150.00 mm to 200.00 mm.

3. The pneumatic vehicle tire of claim 1, wherein the further portion of the sidewall is curved in the form of a circular arc extends up to or almost up to the bead region.

4. The pneumatic vehicle tire of claim 1, as formed immediately after vulcanization in a vulcanizing mold, which vulcanizing mold is provided with a plurality of segments of a segment ring that are arranged movably in the radial direction for forming the tread with shoulder flanks with sidewall shells for forming the sidewalls and with mold partitions between the segments and the sidewall shells, wherein, formed on the outer side of the tire, along those regions that correspond to the positions of the mold partitions are ribs which run around in the circumferential direction and are delimited by a radially inner and a radially outer rib flank and wherein the shoulder flanks are in line with the outer sides that are located radially within the ribs and are interrupted by the ribs,
wherein the rib flanks of the ribs are curved inward in radial section; in the form of a circular arc.

5. The pneumatic vehicle tire as claimed in claim 4, wherein the rib flanks merge tangentially both into the shoulder flanks and into the outer sides of the sidewalls.

6. The pneumatic vehicle tire of claim 5, wherein the curvature of the radially outer rib flank in the form of a circular arc is based on a circular arc with a radius which is in particular at least 0.20 mm greater than the radius of that circular arc which forms the basis for the curvature of the radially inner rib flank in the form of a circular arc, wherein the curvature of the radially outer rib flank in the form of a circular arc is based on a circular arc with a radius which is 1.30 mm to 2.50 mm, and wherein the curvature of the radially inner rib flank in the form of a circular arc is based on a circular arc with a radius which is 1.10 mm to 1.50 mm.

7. The pneumatic vehicle tire of claim 6, wherein the ribs have a height of 1.00 mm to 2.50 mm, in particular of 1.30 mm to 1.70 mm.

8. The pneumatic vehicle tire of claim 7, wherein radially within the ribs in each case there directly adjoins a portion of the sidewall which, when the tire is viewed from the side, forms a circumferential flat surface running around in the form of a circular ring, with a radial extent of 10.00 mm to 25.00 mm, and which merges tangentially into the outer side of a further portion of the sidewall which is formed by a thin amount of extra material of 0.50 mm to 1.50 mm and in radial section is curved outward in the form of a circular arc.

9. The pneumatic vehicle tire as claimed in claim 8, wherein the tire is a commercial vehicle tire, and the further portion of the sidewall curved in the form of a circular arc is based on a circular arc with a radius of 150.00 mm to 200.00 mm.

10. A vulcanizing mold for vulcanizing a pneumatic vehicle tire, the mold comprising:
a number of segments of a segment ring that are arranged movably in the radial direction for forming a tread with shoulder flanks also with sidewall shells for forming sidewalls and with mold partitions between the segments and the sidewall shells wherein, with the mold closed, the sidewall shells are in contact with the segments of the segment ring at the mold partitions wherein respectively formed at the end on the inner side of the mold, along the mold partition is a circumferential depression, which is delimited by two depression flanks one of which is formed on the segments and the other of which is formed on the sidewall shell and wherein, around the region of the mold partitions the mold inner sides are in line with one another, interrupted by the depressions,
wherein
the depression flanks of the depressions are curved outward in radial section, in the form of a circular arc.

11. The vulcanizing mold as claimed in claim 10, wherein the depression flanks of the depressions merge tangentially into the inner sides of the segments and the sidewall shells.

12. The vulcanizing mold as claimed in claim 11, wherein the curvature of the radially outer depression flank in the form of a circular arc is based on a circular arc with a radius which is 1.30 mm to 2.00 mm.

13. The vulcanizing mold as claimed in claim 11, wherein the curvature of the radially inner depression flank in the form of a circular arc is based on a circular arc with a radius which is 1.10 mm to 1.50 mm.

14. The vulcanizing mold as claimed in claim 13, wherein the depressions have a depth of 1.00 mm to 2.50 mm, in particular of 1.30 mm to 1.70 mm.

15. A pneumatic tire system comprising:
a tread;
a shoulder flank;
a sidewall;
a bead region;
the tire formed of a vulcanizing mode immediately after vulcanization;
the mold comprising a sidewall shell, segments of a profile ring and a mold partition between the sidewall shell and the segments of a profile ring;
the sidewall of the tire comprises a rib having two tapered rib flanks;
the rib runs circumferentially around the sidewall;
a tip of the rib has a film of rubber flash formed during vulcanization;
the rib has rib flanks curve inward and concavely and extend from the tip of the rib and merge into the shoulder flank; and
an inner rib flank of the rib flanks has a circular arch with an arc having a radius of 1.3 mm to 2.5 mm.
